(19) United States
(12) Patent Application Publication
(10) Pub. No.: US 2014/0118633 A1
(43) Pub. Date: May 1, 2014

(54) PROJECTED CAPACITIVE TOUCH PANEL

(71) Applicant: Abon Touchsystems Inc., Yilan County (TW)

(72) Inventor: Tse-Kun Chang, Yilan County (TW)

(21) Appl. No.: 13/909,924

(22) Filed: Jun. 4, 2013

(30) Foreign Application Priority Data
Oct. 29, 2012 (TW) 101220884

(51) Int. Cl. G02F 1/1333

(52) U.S. Cl. CPC G02F 1/13338
USPC 349/12

(57) ABSTRACT

A projected capacitive touch panel includes a transparent substrate, an isolation layer, a first and a second transparent conductive circuit layer, a first and a second conductive layer, a transparent substrate film and a protective layer. The isolation layer is formed on a frame region of the transparent substrate, and the first transparent conductive circuit layer is formed on the other region of the transparent substrate and the isolation layer. The first conductive layer is formed on the first transparent conductive layer and is positioned corresponding to the frame region. The second transparent conductive circuit layer is formed on the transparent substrate film. The second conductive layer is formed on the second conductive circuit layer and is positioned corresponding to the frame region. The protective layer is formed on the second conductive layer and the second transparent conductive circuit layer.

### RELATED APPLICATIONS

This application claims priority to Taiwan Application Serial Number 101220884, filed Oct. 29, 2012, which is herein incorporated by reference.

### BACKGROUND

1. Technical Field

The present disclosure relates to a touch panel, and more particularly, a high-transmittance miniaturized projected capacitive structure.

2. Description of Related Art

Touch panels are widely used in existing devices, such as automatic teller machines, point of sale terminals, industrial control systems. Because this interface is easy to use, durable, and is not expensive, the market has experienced continued rapid growth.

Currently available projected capacitive touch panels are mostly manufactured by conventional glass-to-glass full lamination process. Full lamination requires two glass substrate layers to be laminated with optical cement, and hence the manufacturing process is complex and the product is bulky thickness. Further, the demand for more materials and the low yield rate result in a high manufacturing cost.

In view of the foregoing, there exist problems and disadvantages in the current touch panels that await further improvement. However, those skilled in the art sought vainly for a solution. Accordingly, there is an urgent need in the related field to provide a solution that simplifies the manufacturing process and improves the yields rate.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to a next-generation touch panel that is manufactured with a simplified process. In this way, the material cost could be reduced and the yield rate could be improved.

According to one embodiment of the present invention, a projected capacitive touch panel comprises a transparent substrate, an isolation layer, a first and a second transparent conductive circuit layer, a first and a second conductive layer, an adhesive layer, a transparent substrate film and a protective layer. The isolation layer is formed on a frame region of one surface of the transparent substrate, the first transparent conductive circuit layer is formed on the isolation layer and the other region of said surface of the transparent substrate the. The first conductive layer is formed on the first transparent conductive circuit layer, and is positioned corresponding to the frame region. The adhesive layer has one surface in direct contact with the first conductive layer and the first transparent conductive circuit layer, while the transparent substrate film is in direct contact with the other surface of the adhesive layer. The second transparent conductive circuit layer is formed on the transparent substrate film. The second conductive layer is formed on the second transparent conductive circuit layer, and is positioned corresponding to the frame region. The protective layer is formed on the second conductive layer and second transparent conductive circuit layer.

The adhesive layer may be an optical cement layer.

The protective layer may be a silicon dioxide layer.

The first conductive layer may be a first conductive ink pattern.

The second conductive layer may be a second conductive ink pattern.

The isolation layer may be a decorative layer.

The transparent substrate is a single-piece glass substrate.

The technical solution of the present disclosure, as discussed above, provides many advantages and beneficial effects compared with conventional techniques. Because of the technical inventiveness and utility of the present technical solution, it could be widely used in the industry. Technical advantages are generally achieved, by embodiments of the present invention, as follows:

(1) There is no need for two layers of the glass substrate, thereby shortening the distance between two transparent conductive circuit layers, and improving the efficiency of capacitive coupling;

(2) The manufacturing process is simplified, thereby increasing the yield rate.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is an exploded drawing illustrating a projected capacitive touch panel according to one embodiment of the present disclosure;

FIG. 2 is a top-view drawing illustrating a projected capacitive touch panel according to one embodiment of the present disclosure; and

FIG. 3 is a sectional view of a projected capacitive touch panel according to one embodiment of the present disclosure.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise.

The terms “about”, “approximately” and “substantially” are used herein to modify numeral values that may subject to slight variations, yet such variations would not alter the nature of the numeral values. According to embodiments herein, “around”, “about” or “approximately” shall generally mean within 20 percent, preferably within 10 percent, and more preferably within 5 percent of a given value or range, unless otherwise defined.

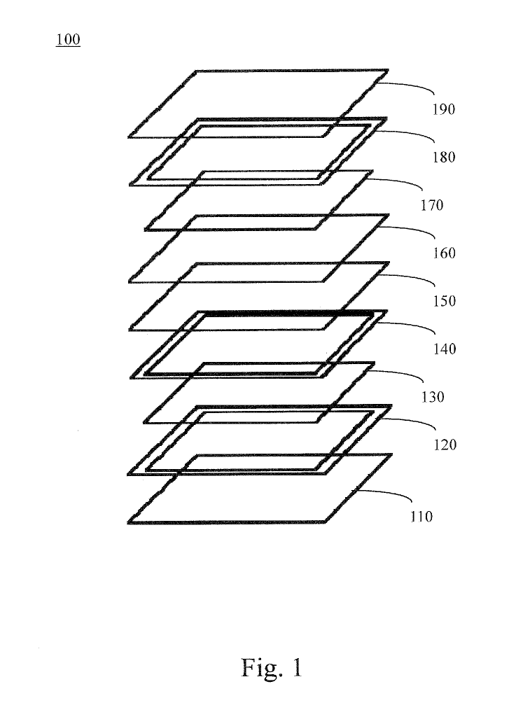

FIG. 1 is an exploded drawing illustrating a projected capacitive touch panel 100 according to one embodiment of the present disclosure. As illustrated in FIG. 1, the projected capacitive touch panel 100 comprises a transparent substrate 110, an isolation layer 120, a first transparent conductive circuit layer 130, a first conductive layer 140, an adhesive layer 150, a transparent substrate film 160, a second transparent conductive circuit layer 170, a second conductive layer 180 and a protective layer 190.

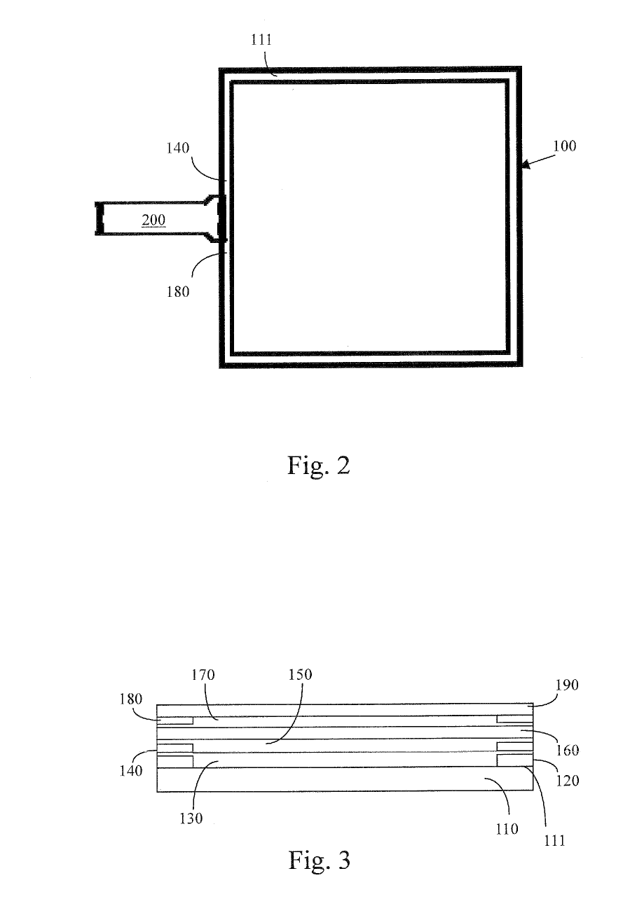

In manufacturing process, the isolation layer 120 is formed on the transparent substrate 110, and then the first transparent conductive circuit layer 130 is formed on the transparent substrate 110 so that the first transparent conductive circuit layer 130 is used the conductive circuit layer of an operation plane. Next, the first conductive layer 140 is formed on the transparent substrate 110 so that the first conductive layer 140 is electrically connected to the first transparent conductive circuit layer 130. In this way, the first transparent conductive circuit layer 130 may conduct the signal via the first conductive layer 140 and the flexible circuit board 210 (illustrated in FIG. 2) to the circuit control board.

On the other hand, after a transparent conductive layer is formed on the transparent substrate film 160, the transparent conductive layer is made into the second transparent conductive circuit layer 170; next, the second conductive layer 180 is further formed on the second transparent conductive circuit layer 170, in which the second conductive layer 180 is electrically connected to the second transparent conductive circuit layer 170. Then, the protective layer 190 is formed. In this way, the second transparent conductive circuit layer 170 may conduct the signal via the second conductive layer 180 and the flexible circuit board 220 (illustrated in FIG. 2) to the circuit control board.

Therefore, the projected capacitive touch panel 100 may comprise a semi-finished first substrate (which comprises the transparent substrate 110, the isolation layer 120, the first transparent conductive circuit layer 130, and the first conductive layer 140) and a semi-finished second substrate (which comprises the transparent substrate film 160, the second transparent conductive circuit layer 170 and the second conductive layer 180). To simplify the manufacturing process and improve the yield rate, the semi-finished first substrate and the semi-finished second substrate are assembled with the adhesive layer 150.

Further, since the thickness of the transparent substrate film 160 is much smaller than that of a glass substrate, the distance between the two conductive circuit layers 130 and 170 are quite short, which in turn improves the efficiency of capacitive coupling.

Regarding the specific structure of the projected capacitive touch panel 100, please refer to FIG. 3, which is a sectional view of the projected capacitive touch panel 100 according to one embodiment of the present disclosure. As illustrated in FIG. 3, the isolation layer 120 is formed on the frame region 111 of one surface of the transparent substrate 110, while the first transparent conductive circuit layer 130 is formed on the isolation layer 120 and the other region of said surface of the first transparent substrate 130. The first conductive layer 140 is formed on the first transparent conductive circuit layer 130, and is positioned corresponding to the frame region 111. One surface of the adhesive layer 150 is in direct contact with the first conductive layer 140 and the first transparent conductive circuit layer 130, whereas the transparent substrate film 160 is in direct contact with the other surface of the adhesive layer 150. The second transparent conductive circuit layer 170 is formed on the transparent substrate film 160. The second conductive layer 180 is formed on the second transparent conductive circuit layer 170, and is positioned corresponding to the frame region 111. The protective layer 190 is formed on the second conductive layer 180 and the second transparent conductive circuit layer 170.

In the present embodiment, the adhesive layer 150 may be an optical cement layer. The protective layer 190 may be a silicon dioxide layer. The material of the transparent substrate 110 may be, for example, an inorganic transparent material (e.g. glass, quartz, other suitable materials, or a combination of the above), an organic transparent material (e.g. polyolefin, polythiourea, polyalcohols, polyester, rubber, a thermoplastic polymer, a thermosetting polymer, polyarylene, polymethylmethacrylate, plastic, polycarbonate, other suitable materials, derivatives of the above, or a combination of the above), or a combination of the above. In one embodiment of the present disclosure, the transparent substrate 110 is a single-piece glass substrate.

Further, the first conductive layer 140 may be a first conductive ink pattern, and the second conductive layer 180 may be a second conductive ink pattern. For example, the material of the conductive ink pattern may be a carbon paste, a silver paste, other suitable materials, or a combination of the above. The isolation layer 120 may be a decorative layer, and this decorative layer may obscure the conductive ink pattern and allow the presentation of the frame pattern.

The transparent substrate film 160 may be a polyester film, optical film or other films. The polyester film has various advantages such as high tensile strength and good impact strength, desirable size stability, high transparency, etc.

The material of the first transparent conductive circuit layer 130 and the second transparent conductive circuit layer 170 may be, for example, indium tin oxide (ITO), indium zinc oxide (IZO), indium tin zinc oxide (ITZO), hafnium oxide, zinc oxide, aluminum oxide, aluminum tin oxide (ATO), aluminum zinc oxide (AZO), cadmium tin oxide (CTO), cadmium zinc oxide (CZO), other suitable materials, or a combination of the above. In the manufacturing process, it may be feasible to form a transparent conductive material first, which is then patterned with suitable process to obtain the transparent conductive circuit layer.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §to 112 (f). In particular, the use of “step of” in the claims herein is not intended to invoke the provisions of 35 U.S.C. §112 (f).

What is claimed is:

1. A projected capacitive touch panel comprising:
a transparent substrate;
an isolation layer, formed on a frame region on one surface of the transparent substrate;
a first transparent conductive circuit layer, formed on the isolation layer and the other region of the surface of the transparent substrate;
a first conductive layer, formed on the first transparent conductive circuit layer, and is positioned corresponding to the frame region;
an adhesive layer, having one surface in direct contact with the first conductive layer and the first transparent conductive circuit layer;
a transparent substrate film, in direct contact with the other surface of the adhesive layer;
a second transparent conductive circuit layer, formed on the transparent substrate film;
a second conductive layer, formed on the second transparent conductive circuit layer, and is positioned corresponding to the frame region;
a protective layer, formed on the second conductive layer and the second transparent conductive circuit layer.

2. The projected capacitive touch panel of claim 1, wherein the adhesive layer is an optical cement layer.

3. The projected capacitive touch panel of claim 1, wherein the protective layer is a silicon dioxide layer.

4. The projected capacitive touch panel of claim 1, wherein the first conductive layer is a first conductive ink pattern.

5. The projected capacitive touch panel of claim 4, wherein the second conductive layer is a second conductive ink pattern.

6. The projected capacitive touch panel of claim 4, wherein the isolation layer. is a decorative layer.

7. The projected capacitive touch panel of claim 1, wherein the transparent substrate is a single-piece glass substrate.
